(19) United States
(12) Patent Application Publication
(10) Pub. No.: US 2026/0171868 A1
(43) Pub. Date: Jun. 18, 2026

(54) Electronic Mechanical Brake

(71) Applicant: Robert Bosch GmbH, Stuttgart (DE)

(72) Inventors: Xiaokun Zhang, Suzhou (CN); Fei Yu, Suzhou (CN); Qiusheng Zhang, Suzhou (CN)

(21) Appl. No.: 19/408,625

(22) Filed: Dec. 4, 2025

(30) Foreign Application Priority Data
Dec. 6, 2024 (CN) 2024 1179 3074.5

(51) Int. Cl. H02K 7/108; H02K 5/04

(52) U.S. Cl. CPC H02K 7/108; H02K 5/04

(57) ABSTRACT

An electromechanical brake includes a main braking module and a braking actuator module. The main braking module includes (i) a motor, (ii) an electronic control unit, and (iii) a housing having an outer wall defining a notch. The braking actuator module includes (i) a housing having a housing wall defining a cavity, and (ii) an actuator assembly disposed in the cavity. The actuator assembly includes a spindle supported by a bearing on an inner side of the housing wall. The housing wall is positioned in the notch, such that (i) the outer wall is positioned to surround the housing wall, and (ii) the motor is connected to the spindle for transmission.

### TECHNICAL FIELD

This application relates to the field of braking devices, and more particularly, to an electromechanical brake.

### BACKGROUND

An electromechanical brake is a device that utilizes an electric motor to actuate a brake caliper for braking. Compared to conventional hydraulic brake systems, it has advantages such as rapid response, simple structure, and ease of maintenance. With the development of vehicle electrification and intelligence, electromechanical brakes have become a development trend of braking systems thanks to their integrability with electric control systems.

Electromechanical brakes are generally assembled from a first module and a second module. The first module comprises a brake motor, a transmission mechanism, and a control unit, while the second module comprises a housing, a friction plate support, etc. Electromechanical brakes have many internal components, and designing an electromechanical brake that is easy to assemble is a challenge.

### SUMMARY OF THE INVENTION

The purpose of the present application is to solve or at least alleviate one or more problems existing in the prior art.

According to one aspect, an electromechanical brake is provided, comprising:
a main braking module, the main braking module comprising: a motor, an electronic control unit, and a housing, the housing comprising an outer wall defining a notch; and
a braking actuator module, the braking actuator module comprising a housing, the housing comprising a housing wall defining a cavity, an actuator assembly being disposed in the cavity, and the actuator assembly comprising a spindle supported by a bearing on the inner side of the housing wall;
wherein during the assembly of the main braking module and the braking execution module, the housing wall of the braking actuator module is inserted into the notch of the main braking module, such that the outer wall is positioned to surround the housing wall and the motor is connected to the spindle for transmission.

The electromechanical brake according to the examples is reasonably designed and easy to assemble.

### BRIEF DESCRIPTION OF THE DRAWINGS

Referring to the drawings, the disclosure of the present application will become more easily understood. It will be readily understood by those skilled in the art that: these drawings are for purposes of illustration only and are not intended to limit the scope of protection of the present application.

Additionally, similar numerals in the drawings are used to represent similar components, wherein:

FIG. 1 shows an exploded view of an electromechanical brake according to an example when assembled to a hub;

FIG. 2 shows a three-dimensional view of the electromechanical brake according to an example;

FIG. 3 shows an exploded view of the electromechanical brake according to an example;

FIG. 4 shows a longitudinal sectional view of the electromechanical brake according to an example;

FIG. 5 shows a three-dimensional view of the housing of the electromechanical brake according to an example;

FIG. 6 shows a cross-sectional view of the housing of the electromechanical brake according to an example;

FIG. 7 shows a longitudinal sectional view of the housing of the electromechanical brake according to an example;

FIG. 8 shows a three-dimensional view of the bearing and clamping ring of the electromechanical brake according to an example;

FIG. 9 shows a partial sectional view of the electromechanical brake according to an example;

FIG. 10 shows a three-dimensional view of the elastic member in FIG. 9;

FIG. 11 shows a partial sectional view of the electromechanical brake according to another example;

FIG. 12 shows a three-dimensional view of the elastic member in FIG. 11;

FIGS. 13 and 14 show three-dimensional views of different angles of the housing of the main braking module according to an example;

FIG. 15 shows a cross-sectional view of the housing of the main braking module according to an example;

FIG. 16 shows a longitudinal sectional view of the assembly process of the electromechanical brake according to an example;

FIG. 17 shows a cross-sectional view of the electromechanical brake according to an example; and

FIG. 18 shows an enlarged view of region A in FIG. 17.

### DETAILED DESCRIPTION OF THE EMBODIMENTS

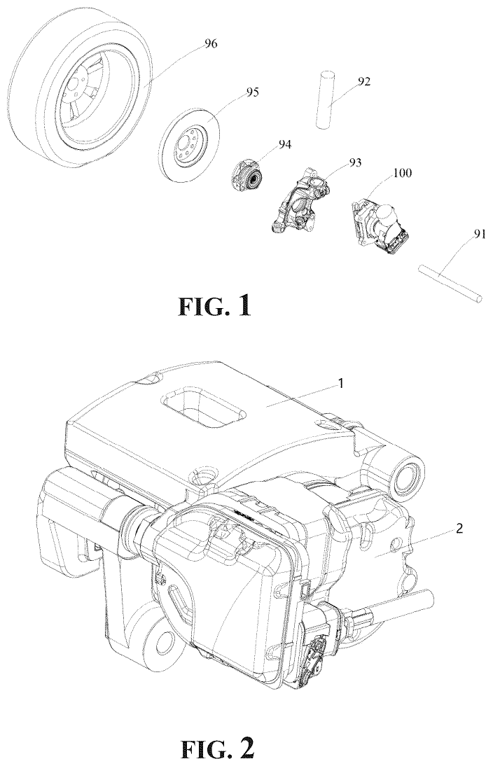

FIG. 1 shows a mounting diagram of an electromechanical brake, wherein a rotating shaft 91, a damper 92, a bearing 94, a steering knuckle arm 93, a brake disc 95, and a wheel 96 as well as an electromechanical brake 100 according to an example are shown, and the electromechanical brake is driven by an electric motor to provide a braking force by clamping the brake disc 95 with a brake caliper. When assembled, the electromechanical brake 100 is mounted on the steering knuckle arm 93, while the electromechanical brake 100 is housed within a compact space inside the hub of the wheel 96, thus having a strict limit on the volume of the electromechanical brake 100 itself.

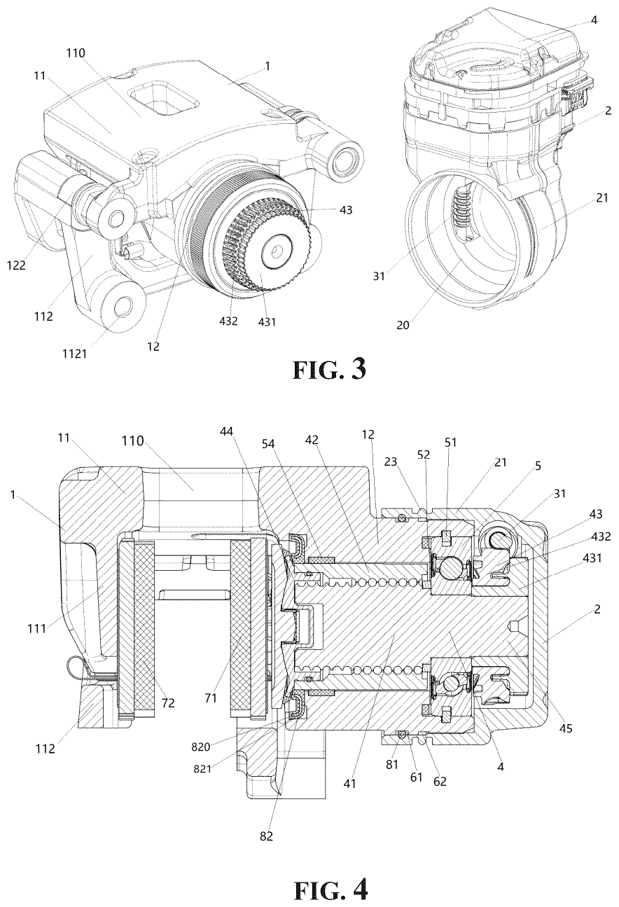

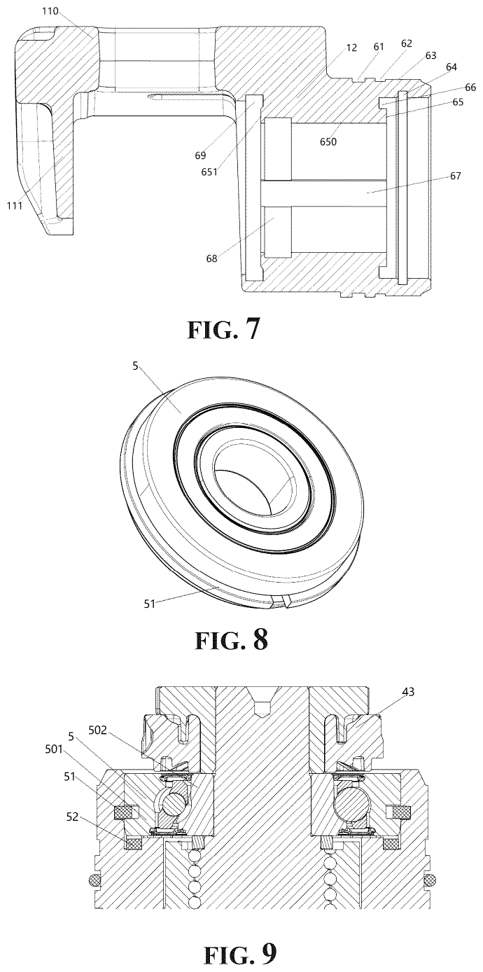

Referring to FIGS. 2 to 18, an electromechanical brake according to various examples will be described. As shown in FIGS. 2 and 3, the electromechanical brake comprises: a braking actuator module 1 and a main braking module 2. The main braking module 2 may comprise: a motor, only the output shaft 31, the electronic control unit 4, and the housing of which are visible in the figure, the housing comprising an outer wall 21 that defines a notch 20. The electronic control unit 4 can be installed at one end of the housing and can be connected to the vehicle via a wiring harness to receive braking control signals and to the motor to control the motor to output appropriate braking torque. The braking actuator module 1 may comprise a housing 11, a brake caliper composed of a friction plate and a friction plate support, an actuator assembly, etc. The housing 11 comprises a housing wall 12 defining a cavity 120, an actuator assembly being disposed in the cavity 120, and the actuator assembly comprising a spindle 4 supported by a bearing 5 on the inner side of the housing wall 12. As shown in the longitudinal sectional view of FIG. 4, when the main braking module 1 and the braking actuator module 2 are assembled, the housing wall 12 of the braking actuator module is inserted into the notch 20 of the main braking module 2, such that the outer wall 21 is positioned to surround the housing wall 12 and the motor, such as its output shaft 31, is connected to the spindle 4 for transmission.

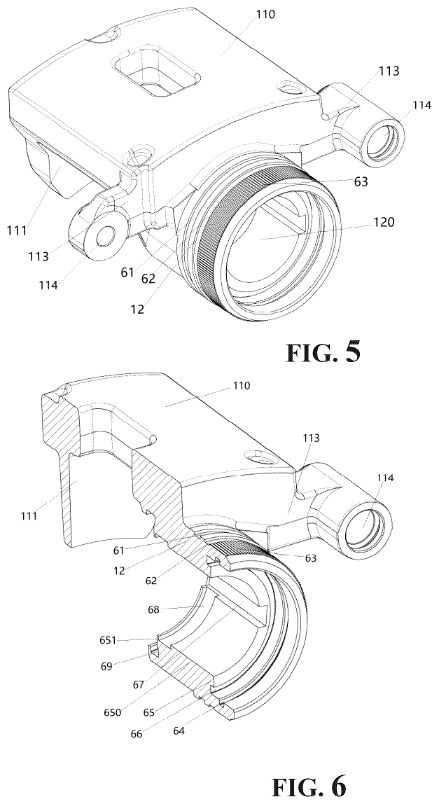

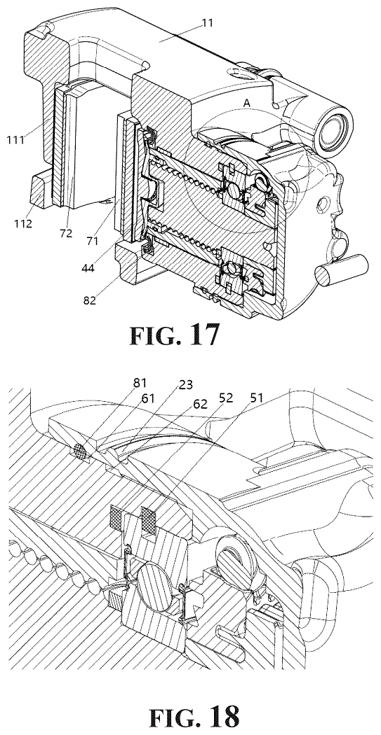

The outer wall 21 and the housing wall 12 may both be cylindrical in shape, and when the outer wall 21 surrounds the housing wall 12, the two are tightly joined together, with only an assembly gap. The outer wall 21 may be connected with the housing wall 12 in any suitable manner, such as welding, bonding, etc. In some examples, referring to FIGS. 5 to 7, the outer surface of the housing wall 12 has a first slot 62 along the circumferential direction, and the outer wall 21 fills the first slot 62 by deformation, thereby connecting the main braking module 1 with the braking actuator module 2, a process also known as caulking or crimping. In some examples, referring to FIGS. 17 and 18, the outer surface of the outer wall 21 comprises at least one convex rib 23. When the at least one convex rib 23 on the outer surface of the outer wall 21 is aligned with the first slot 62 (the state in FIG. 18), a force is applied to the at least one convex rib 23, causing the at least one convex rib 23 to deform toward the first slot 62 to fill the first slot 62, thereby achieving connection. To achieve such a combination, the outer wall 21 may be made of aluminum-based materials or other metallic or non-metallic materials having good deformation capabilities, and the deformation can be achieved by extrusion with a pressure head. The extrusion process, e.g., involves pressing the convex rib 23 into the first slot 62 at a point with the pressure head, and then rotating the assembly to press the entire convex rib 23 into the first slot 62.

With continued reference to FIGS. 5 to 7, in some examples, the outer surface of the housing wall has a second slot 61 along the circumferential direction, the second slot 61 being parallel to the first slot 62, and a first seal 81, such as a sealing ring, being arranged in the second slot 61, the first seal 81 sealing the gap between the housing wall 12 and the outer wall 21. In the illustrated example, the first slot 62 is closer to the end of or further out than the second slot 61. In some examples, the outer surface of the housing wall 12 further comprises anti-rotation teeth 63 along the circumferential direction, the anti-rotation teeth 63 being interference-fitted into the notch 20 of the outer wall 21. The anti-rotation teeth 63 achieve circumferential restraint between the two by interference fit with the outer wall 21 and axial restraint between the two by the aforementioned caulking or crimping. In the illustrated example, the anti-rotation teeth 63 are located further out than or closer to the end of the first slot 62. The anti-rotation teeth 63 can be formed by a cylindrical scraper acting on the outside of the cover wall 12. In some examples, the anti-rotation teeth can be formed by two processes: coarse scraping and fine scraping. Although in the illustrated example, the anti-rotation teeth 63 are formed along the entire circumference, in alternative examples, the anti-rotation teeth 63 may also occupy only one or more arc segments. The restraint and sealing between the housing wall 12 and the outer wall 21 may be achieved by the placement of the first slot 62, the second slot 61, and the anti-rotation teeth 63 on the outer side of the housing wall 12.

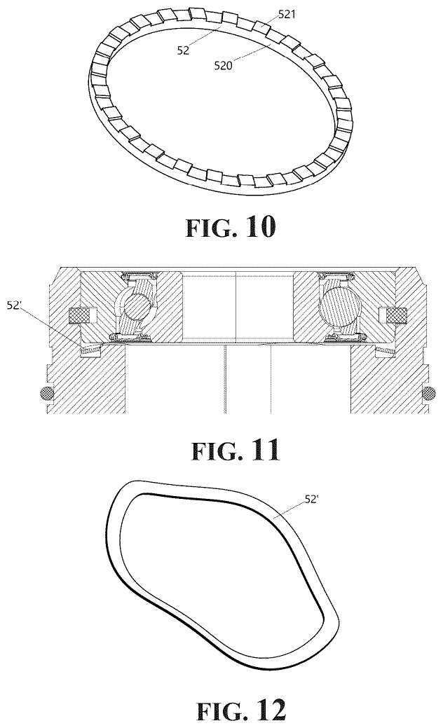

Before the main braking module 1 and the braking actuator module 2 are assembled, the actuator assembly needs to be assembled with the housing first. In some examples, the inner surface of the housing wall 12 comprises a third slot 64 along the circumference direction, and the bearing 5 is engaged through a clamping ring 51 with the third slot 64. More specifically, as shown in FIG. 8, the outer ring of the bearing 5 has a clamping ring slot. The clamping ring 51 may be compressed in the clamping ring slot and inserted with the bearing inside the housing wall 12, with the clamping ring 51 unfolding at the third slot 64, thereby providing for axial restraint for the bearing 5. As is clearly shown in FIG. 9, the inner diameter of the third slot 64 is disposed such that the clamping ring 51 still overlaps radially with the third slot 64 and the clamping ring slot when the third slot 64 is unfolded. In some examples, the inner surface of the housing wall 12 further comprises a boss 650, the boss 650 comprising a first shoulder 65 facing the third slot 64 and the elastic member 52 being disposed between the first shoulder 65 and the bearing 5. The configuration of the elastic member 52 provides an outward thrust to the outer ring 501 of the bearing 5, while the clamping ring 51 prevents the outer ring 501 of the bearing 5 from moving outward, thereby achieving axial restraint of the bearing 5. The bearing 5 may be a thrust bearing. In some examples, a fourth slot 66 is provided along the circumferential direction at the first shoulder 65, and the elastic member 52 may be embedded in the fourth slot 66. As shown in FIGS. 9 and 10, in some examples, the elastic member 52 may be an elastic washer, which may comprise, for example, an annular body 520 embedded in the fourth slot 66 and a plurality of protruding blocks 521 disposed at intervals extending from the annular body 520 towards the bearing 5. As shown in FIGS. 11 and 12, in alternative examples, the elastic member 52 may be a wave spring 52′. A portion of the wave spring 52′ is embedded in the fourth slot 66, and a portion provides elastic force to the bearing 5. In still other alternative examples, the elastic member 52 may also be a disc spring, a coil spring, etc.

With continued reference to FIG. 3, in some examples, the spindle 4 comprises a first end 45 and a second end 41 opposite to each other. The first end 45 of the spindle 4 extends out of the housing wall 12 and is fixedly connected to an input gear 43. The second end 41 of the spindle is formed as the screw of a ball screw mechanism, and the nut 42 of the ball screw mechanism is connected to an end plate assembly 44. The input gear 43 receives input torque from the motor and converts it into translation of the end plate assembly 44 via the ball screw mechanism. In some examples, the input gear 43 is configured as a worm gear, the output shaft 31 of the motor is configured as a worm and extends to the notch 20, and when the main braking module 2 and the braking actuator module 1 are assembled, the worm gear 43 enters the notch 20 to engage the output shaft 31 of the motor. Utilizing the worm gear structure allows the motor to be arranged transverse to the spindle 4, thereby making better use of the compact space. In alternative examples, the input gear 43 may be a common gear, and the motor output shaft 31 may be arranged parallel to the spindle 4 and engage the input gear 43 through the gear. In some examples, the input gear 43 may comprise an inner ring 431 made of a first material and an outer ring 432 made of a second material. The inner ring 431 may be made of metal, for example, to improve its connection strength with the spindle, while the outer ring may be made of plastic or the like. Through the mechanism described above, the rotation of the motor output shaft 31 will be converted into the translation of the end plate assembly 44. For example, if the motor rotates in a first direction, the end plate assembly 44 will move towards a first friction plate 71. If the motor rotates in a second direction opposite to the first direction, the end plate assembly 44 will move away from the first friction plate 71. The rotation of the motor is controlled by the electronic control unit 4. The electronic control unit 4 controls the motor according to the vehicle's braking requirements to provide the required braking torque.

In some examples, the inner surface of the housing wall 12 further comprises a fifth slot 68 along the circumferential direction, with a sliding bearing 54 being arranged in the fifth slot 68 to guide the axial sliding of the nut 42. In some examples, the fifth slot 68 may be disposed on the boss 650. In some examples, the inner surface of the housing wall further comprises at least one anti-rotation slot 67 along the axial direction, and the outer surface of the nut 42 comprises a protrusion, such as a slider, that engages with the anti-rotation slot 67. In the illustrated example, a pair of anti-rotation slots 67 is provided. As shown in the figure, the anti-rotation slots 67 may also be disposed on the boss 650, e.g., they can run through the entire boss 650. In some examples, the boss 650 comprises a second shoulder 651 facing the first friction plate 71, with a sixth slot 69 along the circumferential direction disposed on the front side of the second shoulder 651, and a second seal 82 embedded in the sixth slot 69 to provide a seal between the nut 42 and the housing wall 12. The second seal 82 is a U-shaped sealing ring and comprises a skeleton 820 and an elastic coating 821, such as a rubber coating, formed on the skeleton.

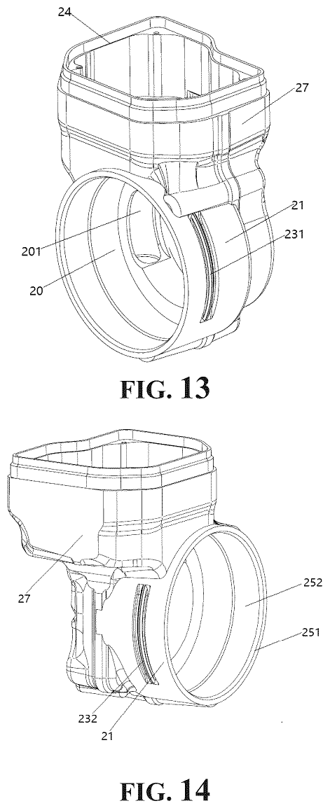

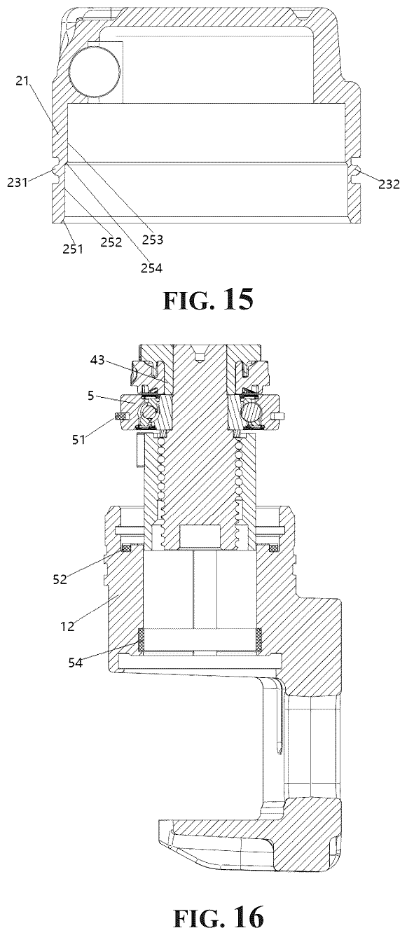

With continued reference to FIGS. 13 to 15, the housing of the main braking module 2 is shown. The housing of the main braking module 2 comprises an outer wall 21 and an additional housing portion 27 connected to the outer wall, the additional housing portion 27 comprising an open top 24. The additional housing portion 27 is used to house the motor and its open top 24 is covered by the electronic control unit 4. As shown in FIG. 13, a space 201 is provided at one side of the notch 20 for arranging the motor output shaft. Further, in the illustrated example, both sides of the outer wall 21 comprise two convex ribs 231 and 232, the two convex ribs 231 and 232 being arranged opposite to each other. As can be seen from FIG. 15, the inner wall of the notch 20 is divided into a plurality of sections, comprising an inlet guide section 251, a first section 252, a transition guide section 254, and a second section 253. The second section 253 has a reduced diameter for interference fit with the anti-rotation teeth of the housing wall 12. The transition guide section 254 is used to direct the ingress of the anti-rotation teeth and the first section 252 is used to engage with the first slot 62 and the second slot 61. The housing 21 of the main braking module 2 may be made of an aluminum-based material.

As shown in FIG. 16, the sliding bearing 54 and the elastic member 52 are first assembled to the housing wall 12 prior to assembly. The spindle 4 is also connected to the bearing 5, such as by an interference fit to the bearing inner ring 502, and then the input gear 43 is installed to the spindle 4. The assembly of the spindle 4 and bearing 5 is then inserted into the housing wall 12 and fixed in place by the clamping ring 51.

In some examples, the braking actuator module further comprises a friction plate support 112, the friction plate support 112 comprising mounting holes 1121 for fixed installation on a vehicle. The first friction plate 71 and the second friction plate 72 are disposed on the friction plate support 112 and are capable of movement along the friction plate support 112. The housing 11 is slidably mounted on the friction plate support 112, and the cavity 120 of the housing 11 connects to the first friction plate 71 such that the end plate assembly 44 can act on the first friction plate 71.

In some examples, the housing 11 comprises a housing body 110 covering the first friction plate 71 and the second friction plate 72. The outer end of the housing body 110 (left side in FIG. 4) has a hook portion 111 that acts on the second friction plate 72, and the cylindrical housing wall 12 is disposed at the inner end of the housing body 110. As shown in FIG. 5, the inner end of the housing body 110 has a pair of flanges 113 on both sides. The pair of flanges 113 each comprise mounting holes 114, thereby connecting to a first guide pin and a second guide pin that are parallel to each other. The housing 11 is slidably mounted to a pair of guide holes 122 of the friction plate support 112 through the first guide pin and the second guide pin, thereby enabling the housing 11 to be movably mounted to the friction plate support 112 relative to the friction plate support 112. Further, the housing wall 12 is integrally formed with the housing body 110. This design reduces the number of parts and simplifies the assembly process compared to a separate housing wall 12. For details on the specific structure and operation of the electromechanical brake, please refer to Chinese invention patent application CN117267280A entitled “Electromechanical Brake,” the full text of which is incorporated herein by reference. The electromechanical brake according to the examples of the present application realizes a reasonable design of the main braking module 2 and the brake caliper module 1, which facilitates the assembly of the two.

The specific examples described above in the present application are intended to only describe the principles of the present application more clearly, i.e., clearly illustrate or describe various components to make the principles of the present disclosure easier to understand. Within the scope of the present application, those skilled in the art can easily make various modifications or changes to the present application. Therefore, it should be understood that these modifications or changes are all comprised within the scope of the patent protection of the present application.

1. An electromechanical brake, comprising:
a main braking module including (i) a motor, (ii) an electronic control unit, and (iii) a housing having an outer wall defining a notch; and
a braking actuator module including (i) a housing having a housing wall defining a cavity, and (ii) an actuator assembly disposed in the cavity the actuator assembly including a spindle supported by a bearing on an inner side of the housing wall,
wherein the housing wall of the braking actuator module is positioned in into the notch of the main braking module, such that (i) the outer wall is positioned to surround the housing wall, and (ii) the motor is connected to the spindle for transmission.

2. The electromechanical brake according to claim 1, wherein:
an outer surface of the housing wall has a first slot along a circumferential direction,
the outer wall fills the first slot by deformation to connect the main braking module with the braking actuator module, and
an outer surface of the outer wall defines at least one convex rib aligned with the first slot, such that a force is applied to the at least one convex rib, causing the at least one convex rib to deform toward the first slot to fill the first slot.

3. The electromechanical brake according to claim 2, wherein:
the outer surface of the housing wall has a second slot along the circumferential direction,
the second slot is parallel to the first slot,
a first seal is arranged in the second slot, and
the first seal is configured to seal a gap between the housing wall and the outer wall.

4. The electromechanical brake according to claim 2, wherein:
the outer surface of the housing wall further includes anti-rotation teeth along the circumferential direction, and
the anti-rotation teeth are interference-fitted into the notch of the outer wall.

5. The electromechanical brake according to claim 2, wherein:
an inner surface of the housing wall includes a third slot along the circumferential direction,
the bearing is engaged through a clamping ring with the third slot,
the inner surface of the housing wall further includes a boss,
the boss includes a first shoulder facing the third slot,
an elastic member is disposed between the first shoulder and the bearing,
a fourth slot is provided along the circumferential direction at the first shoulder, and
the elastic member is an elastic washer or a wave spring embedded in the fourth slot.

6. The electromechanical brake according to claim 1, wherein:
the outer wall and the housing wall are both cylindrical,
the spindle defines a first end and a second end opposite to the first end,
the first end of the spindle extends out of the housing wall and is fixedly connected to an input gear,
the second end of the spindle is formed as a screw of a ball screw mechanism,
a nut of the ball screw mechanism is connected to an end plate assembly,
the input gear is configured as a worm gear,
an output shaft of the motor is configured as a worm and extends to the notch, and
the worm gear enters the notch to engage the output shaft.

7. The electromechanical brake according to claim 6, wherein:
an inner surface of the housing wall includes a fifth slot along a circumferential direction,
a sliding bearing is arranged in the fifth slot and is configured to guide axial sliding of the nut in an axial direction,
the inner surface of the housing wall further includes at least one anti-rotation slot along the axial direction,
an outer surface of the nut defines a protrusion configured to engage with the at least one anti-rotation slot,
the inner surface of the housing wall further defines a boss, and
the fifth slot and the at least one anti-rotation slot are disposed on the boss.

8. The electromechanical brake according to claim 6, wherein:
the braking actuator module further includes a friction plate support,
a first friction plate and a second friction plate are disposed on the friction plate support,
the housing of the braking actuator module is slidably mounted on the friction plate support, and
the cavity connects to the first friction plate, such that the end plate assembly acts on the first friction plate.

9. The electromechanical brake according to claim 8, wherein:
the housing of the braking actuator module includes a housing body covering the first friction plate and the second friction plate,
an outer end of the housing body has a hook portion configured to act on the second friction plate, and
the housing wall is disposed at an inner end of the housing body,
the inner end of the housing body includes a first pair of flanges and a second pair of flanges,
the first pair of flanges is connected to a first guide pin,
the second pair of flanges is connected to a second guide pin that is parallel to the first guide pin,
the housing of the braking actuator module is slidably mounted to the friction plate support through the first guide pin and the second guide pin, and
the housing wall is integrally formed with the housing body.

10. The electromechanical brake according to claim 8, wherein:
an inner surface of the housing wall includes a boss,
the boss includes a second shoulder facing the first friction plate,
a sixth slot along a circumferential direction is disposed on a front side of the second shoulder,
a second seal is embedded in the sixth slot to provide a seal between the nut and the housing wall,
the second seal is U-shaped, and
the second seal includes a skeleton and an elastic coating formed on the skeleton.
